(19) United States
(12) Patent Application Publication
(10) Pub. No.: US 2021/0033062 A1
(43) Pub. Date: Feb. 4, 2021

(54) TURBINE CONTROL

(71) Applicants: Samarth JAIN, Gurugram (IN); Dishant MISHRA, bareilly, Uttar Pradesh (IN)

(72) Inventors: Dishant MISHRA, (US); Samarth JAIN, (US); Gyan ARORA, (US); Ravishant VAISHNAW, (US)

(21) Appl. No.: 17/045,211

(22) PCT Filed: Apr. 5, 2019
(86) PCT No.: PCT/IN2019/050284

§ 371 Date: Oct. 5, 2020

(30) Foreign Application Priority Data
Apr. 5, 2018 (IN) 201811012943

(51) Int. Cl. F03B 15/00; F03D 7/02; F03D 7/04; F03D 9/12

(52) U.S. Cl. CPC F03B 15/00; F03D 7/0276; F03D 7/0284; F03D 7/048; F05B 2270/20; F05B 2210/16; F05B 2260/42; F05B 2260/8211; F03D 9/12

(57) ABSTRACT

The present invention provides a turbine control system and method. The turbine control system includes at least one control means accommodated on a turbine rotor wherein the control means is actuated by a controller in a first or second direction on a plane of the rotor turbine to control a rate of change of moment of inertia of the turbine and thereby controlling the operation of the turbine. The invention also provides a turbine farm including a plurality of turbines operating to provide a maximum and stable power output. The farm includes a master controller configured for controlling the operation of each of the plurality of turbines and individual controller of the turbines efficiently.

### FIELD OF THE INVENTION

The present invention relates to turbines. More particularly, the invention relates to system and method for controlling operation of the turbines.

### BACKGROUND

Traditionally, turbines are well known for generation of electricity using wind or water tides as the source. For eg., wind turbines take input energy from flowing wind and converts the kinetic energy possessed by the wind into electricity. Flowing wind pass over aerodynamic members of turbine to generate rotary motion at its hub. The hub is connected to a shaft which turns the generator to generate electricity.

Turbines are subjected to varying aerodynamic loads which creates disturbances in electrical power output of the turbine and the entire turbine farm. This causes transient and dynamic instability in grid's frequency. Also, the major components of the turbine are subject to damaging vibrational loads.

Further, existing turbines use pitch actuation mechanism. The mechanism reduces the aerodynamic efficiency of the turbine to stabilize turbine's power output or prevent turbine from certain damaging cyclic loads or restrict the noise production of the turbines. Due to these constraints, the turbines discard a lot of wind energy available and are less energy efficient.

In view of the above, there exists a need of improved systems and methods that overcome the shortcomings associated with existing technologies and prior arts.

### SUMMARY OF THE INVENTION

Accordingly, the present invention provides a control method for operating a turbine. The method includes the steps of actuating at least one control means coupled to the turbine in a first direction when the turbine operates above a rated power output on receipt of excess energy wherein a first portion of the excess energy is stored as energy of the actuated control means. The method further includes storing a second portion of the excess energy in at least one storage means, and actuating at least one control means in a second direction by the stored energy when the turbine operates below the rated power output, wherein the at least one control means is actuated in the first direction or the second direction to control the rate of change of moment of inertia of the turbine.

In a related embodiment, the present invention provides a control system for operating a turbine. The system includes at least one control means coupled to a turbine rotor plane wherein the control means actuates in a first direction when the turbine operates above a rated power output on receipt of excess energy wherein a first portion of the excess energy is stored as energy of the actuated control means. The system also includes at least one storage means configured for storing a second portion of the excess energy wherein the at least one control means is actuated in a second direction by the stored energy when the turbine operates below the rated power output, and a controller encoded with instructions enabling the controller to actuate the at least one control means in the first direction and the second direction to control the rate of change of moment of inertia of the turbine.

In an embodiment, the present invention provides a turbine farm control system. The system includes a plurality of turbines wherein each of the plurality of turbines include at least one control means coupled to a turbine rotor plane wherein the control means actuates in a first direction when one or more of the plurality of turbines operates above a rated power output on receipt of excess energy wherein a first portion of the excess energy is stored as energy of the actuated control means. The system includes at least one storage means configured for storing a second portion of the excess energy wherein the at least one control means is actuated in a second direction by the stored energy when the one or more turbines operates below the rated power output, and a controller encoded with instructions enabling the controller to actuate the at least one control means in the first direction and the second direction to control a rate of change of moment of inertia of the one or more turbines; and a master controller encoded with instructions enabling the master controller to control the plurality of turbines and thereby controlling actuation of the at least one control means of one or more turbines of the plurality of turbines in the first direction and the second direction to control rate of change of moment of inertia of each of the plurality of turbines wherein the master controller is configured for operating each of the plurality of turbines such that a maximum and stable power is generated from the turbine farm.

In a related embodiment, the present invention provides a control method for operating a turbine farm. The method includes the steps of determining by a master controller, a difference between an electric power demand and an electric power supply at the turbine farm based on a grid frequency, in response to determination of the difference as negative based on receipt of excess energy, actuating at least one control means of one or more of a plurality of turbines in a first direction to make the net torque acting on the turbines negative wherein a first portion of the excess energy is stored as energy of the actuated control means. The method also includes storing a second portion of the excess energy in at least one storage means, and in response to determination of the difference as positive based on receipt of excess energy, actuating at least one control means of one or more of a plurality of turbines in a second direction by the stored energy to make the net torque acting on the turbines positive, wherein the master controller is configured for identifying the one or more turbines of the plurality of turbines in the farm for deacceleration or acceleration thereby adjusting electrical power output to ensure stable electricity generation from the turbine farm.

In an exemplary embodiment, the control system and method of the present invention maintains optimum progression of tip speed ratio for a turbine with variable moment of inertia. The governing equation introduced for the variable inertia rotor operation, provide inertial torque. The control system increases the annual energy output of the variable inertia turbine by storing the energy above turbine rated wind speed in form of inertial torque and supplying it later.

In an advantageous aspect, the system and method of the present invention controls the inertial torque to improve the vibrational behavior of wind turbine blades, tower and gearbox, to reduce the mechanical loads on the said components. Reduction in mechanical load further reduces fatigue damage and increases the lifespan of major components of the wind turbine.

In an embodiment, the system controls the inertial torque, to serve as solution for transient and dynamic grid stability issues thereby resulting in lesser number of power curtailment events in a year to better the integration of large farms with grid and more energy generation. Further, the system controls the inertial torque, to limit rotor speed while maintaining improved energy output for noise restricted turbines.

### DESCRIPTION OF THE DRAWINGS

FIG. 1 shows a block diagram of a turbine control system in accordance with an embodiment of the present invention.

FIG. 1a shows a graph of the maximum power coefficient of the wind turbine given by Cₚₘₐₓ observed at an optimum value of tip speed ratio given by λₒ in accordance with an embodiment of the present invention.

FIG. 2 shows a flowchart depicting control method of turbine with energy gain in accordance with an embodiment of the present invention.

FIG. 3 shows a flowchart for turbulence intensity of an energy source like wind energy in accordance with an embodiment of the present invention.

FIG. 4 shows a flowchart depicting LVRT and grid line overloading event in accordance with an embodiment of the present invention.

FIG. 5 shows a flowchart depicting method for maintaining power supply and demand in a wind farm in accordance with an embodiment of the present invention.

FIG. 5a shows a block diagram of a wind turbine farm in accordance with an embodiment of the present invention.

FIG. 6 shows a flowchart depicting a turbine control method in case of mechanical vibration of turbine components in accordance with an embodiment of the present invention.

### DESCRIPTION OF THE INVENTION

Various embodiment of the present invention provides system and method for turbine control. The following description provides specific details of certain embodiments of the invention illustrated in the drawings to provide a thorough understanding of those embodiments. It should be recognized, however, that the present invention can be reflected in additional embodiments and the invention may be practiced without some of the details in the following description.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or module is referred to as being “on,” “connected to,” or “coupled to” another element or module, it can be directly on, connected to, or coupled to the other element or module or intervening elements or modules that may be present. As used herein, the term “and/or” includes any and all combinations of one or more of the associated listed items.

Spatially relative terms, such as “control means,” “masses,” “rotor” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

Embodiments described herein will refer to plan views and/or cross-sectional views by way of ideal schematic views. Accordingly, the views may be modified depending on simplistic assembling or manufacturing technologies and/or tolerances. Therefore, example embodiments are not limited to those shown in the views but include modifications in configurations formed on basis of assembling process. Therefore, regions exemplified in the figures have schematic properties and shapes of regions shown in the figures exemplify specific shapes or regions of elements, and do not limit the various embodiments including the example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, the various embodiments including the example embodiments relate to system and method for turbine control. While the example embodiment may be explained with wind energy as the source of energy for driving the turbines, it shall be understood to a person skilled in the art that the same or similar process and system may be utilized for other energy sources like tidal waves where the source is in a different form like fluid, without departing from the scope of the present invention. The application of the process and system as explained in various embodiment may be implemented for other applications within the scope of the present disclosure.

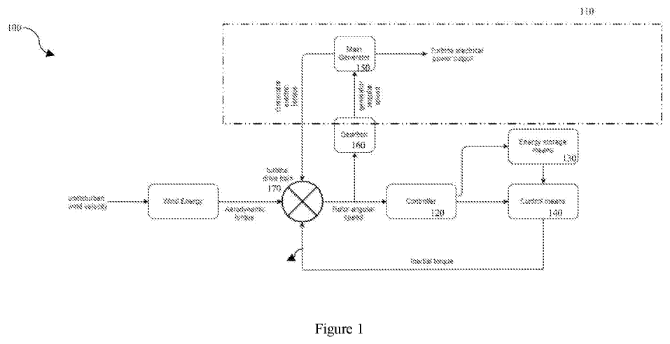

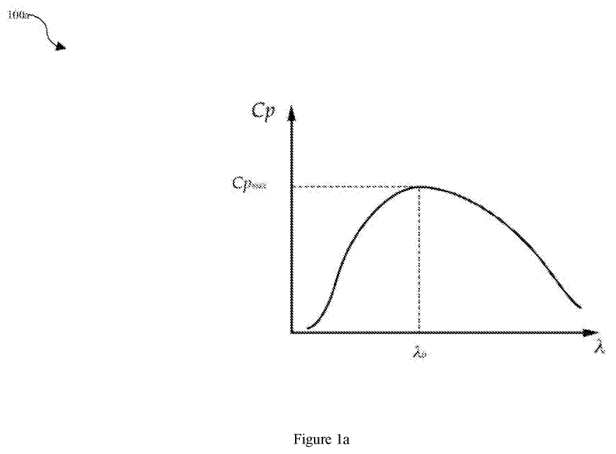

Referring to FIG. 1, a control system 100 for operating a turbine is provided in accordance with an embodiment of the present invention. The system 100 includes a turbine 110, a controller 120, energy storage means 130, at least one control means 140, a generator 150, a gearbox 160 and a turbine drivetrain 170 receiving an energy from as source like wind or tides.

The at least one control means 140 is coupled to a turbine rotor plane. The control means 140 actuates in a first direction when the turbine 110 operates above a rated power output on receipt of excess wind or tidal energy. The first portion of the excess energy is stored as energy of the actuated control means 140. The at least one energy storage means 130 is configured for storing a second portion of the excess energy and the at least one control means 140 is actuated in a second direction by the stored energy when the turbine operates below the rated power output. The controller 120 is encoded with instructions that enables the controller 120 to actuate the at least one control means 130 in the first direction and the second direction to control the rate of change of moment of inertia of the turbine 110.

In an example embodiment, the control means 140 actuate in a radially outward direction as the first direction and actuates in a radially inward direction as the second direction.

The kinetic energy in the wind or tides, passing over the turbine, is a function of the cube of undisturbed wind or tidal velocity and area swept by a turbine blade. Flowing wind or tide discharges part of its kinetic energy to the turbine blades through aerodynamic effect while the remaining energy egresses to maintain flow after passing the turbine.

In an embodiment, the turbine control system 100 maximizes the power output of the generator 150. It is programmed to mechanically operate the turbine at such desired angular velocities so to achieve maximum power output or power coefficient. While there is a limit to which generator 150 can accept power from the turbine 110, the wind/tidal velocity at which turbine 110 generates its rated electrical output is known as rated velocity.

The present invention provides the control system for wind turbine equipped with mechanism which aims to provide a mechanical energy storage medium between aerodynamic members and electrical system of the wind turbine. The system design of a variable inertia wind turbine has blades such that, there are movable control means/masses placed inside the blade along its length for translating them radially along the length of the blade during the operations of the turbine. The movable masses are configured to occupy minimum length along the blade, concurrently large enough to impact a sizable change in moment of inertia of the turbine rotor, while translating from one extreme to the other across the length of the blade. Movable masses are controlled by a regenerative motor which is further connected to a battery storage.

In an exemplary embodiment, the turbine with variable moment of inertia uses the following mathematical relationship given in equation (1). It provides accelerating or decelerating torque according to the needs of the turbine for achieving best efficiency and to maximize Annual Energy production.

Iᵣₒₜₒᵣαᵣₒₜₒᵣ=τₐₑᵣₒ−τ_{gen}−ωDIᵣₒₜₒᵣ/dt−l (1)

Further, in the above equation (1), net torque is represented by the right side of the equation, which is the difference of aerodynamic (τₐₑᵣₒ) and generator (τ_{gen}) torque while the balance (ωᵣₒₜₒᵣ*dIᵣₒₜₒᵣ/dt) is termed as Inertial torque. Inertial torque here is defined as the balancing torque supplied or consumed to compensate according to rate of change of moment of inertia of turbine due to change in position of the said movable mass. l refers to the torque losses due to undesired effects incurred in the electro-mechanical system when turbine is producing electrical power.

In another exemplary embodiment, the control system of the present invention utilizes a turbine with multiple components functioning together and structured such that maximum and stable output power is achieved for a longer duration. Some of the components include rotor plane, which is the plane/s perpendicular to the axis of the main shaft and which through bearings, supports the wind turbine rotor assembly, where the quarter chord lines intersect, or pass closest to, the rotor axis or plane/s is parallel to it. Further, rotor plane can be a plane of any rotating body along the turbine that transfers the rotation from rotor to generator, before being converted into electrical energy by the main generator. The system includes a regenerative motor which can supply torque to the turbine pulley by using electrical power in motor action, while it can utilize mechanical torque available at pulley to generate electrical power in generator action. The regenerative motor is connected to an electrical energy storage (or battery) system to store or supply electrical energy.

In an embodiment, the present invention analyzes multiple parameters associated with a wind or tidal turbine for controlling the operation of the turbine to ensure maximum and stable output power for a longer duration. Some of the parameters include Undisturbed wind/tidal velocity (Vinf) which is the velocity of naturally occurring wind or tides approaching the face of a turbine however its magnitude or direction is unaffected by the presence of such an obstacle like wind turbine. Also, Tip speed Ratio (TSR) which is the ratio of the velocity of the tip of the blade of turbine Vtip to an undisturbed wind velocity Vinf is analyzed. The Power coefficient (Cp) which is the ratio of wind turbine output power, or power extracted by the turbine, to its input power supplied by flowing wind is utilized for operating the turbine efficiently. For each wind velocity there is a specific angular velocity of the turbine rotor at which best aerodynamic efficiency is achieved and power coefficient is maximum.

In an embodiment, the optimum tip speed ratio of a turbine is dependent on multiple factors including structural configuration of the turbine and its components itself. It shall be apparent to a person skilled in the art that the optimum tip speed ratio varies depending on multiple conditions and operational requirements of the turbine. Any such determination of a value of the optimum tip speed with varying structure of the turbines shall be within the scope of the present invention.

The system analyzes noise restricted wind velocity in noise restricted turbines, which is the undisturbed wind velocity at which the maximum noise restricted rotor speed, to maintain turbine operations below noise limitation, is reached. Also, Capacity factor of the turbine which is the ratio of annual energy generation by the turbine to the maximum generation, turbine can generate at rated capacity throughout the year is assessed.

In an example embodiment, an inertial torque is analyzed for controlling operation of the turbine. While an excess torque is present, the movable masses are configured to move radially outwards in the rotor plane or away from the hub to provide a decelerating inertial torque (or positive inertial torque for equation 1) that matches the excess torque present and hence converts the excess wind energy into movable mass's radial and tangential kinetic energy which ultimately gets stored partially in the form of rotational kinetic energy of the mass and partially supplied as electrical energy to electrical storage system attached to regenerative motors.

The maximum power coefficient of the wind turbine given by Cₚₘₐₓ is observed at an optimum value of tip speed ratio given by λₒ as shown in graph 100a of FIG. 1a. Further, the system of the present invention analyzes parameters such as Critical frequency value which is that value at which the vibration damping rate is not enough and hence amplification of vibration amplitude takes place leading to structural damage. Also, Critical turbulence intensity value which is that value at which the intensity of fluctuations in undisturbed wind velocity lead to fluctuating electrical power output of a wind turbine or wind farm as a whole that is not acceptable by the grid is analyzed. Further, apparent maximum electrical power output is analyzed where electrical power output of a wind turbine is said to be at apparent maximum electrical power output when maximum possible value of positive inertial torque that could be provided in the next time step, without violating the hardware limitations of the mass actuation system, by moving the said disposed masses radially inwards will lead to an electrical power output of the wind turbine generator that would be equal to or above the max electrical power output that wind turbine generator can supply.

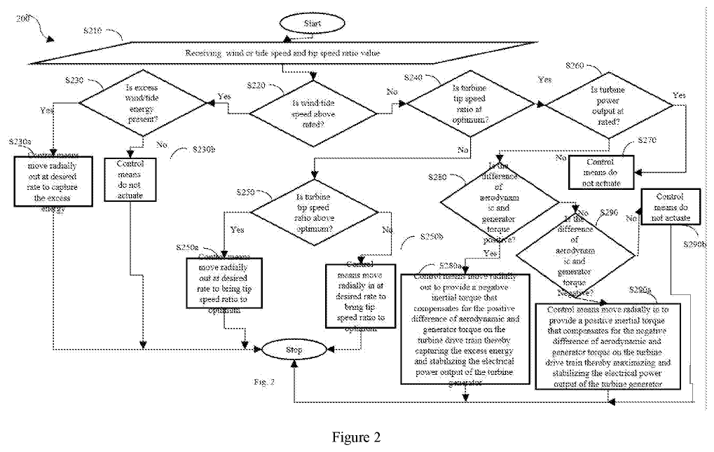

Referring to FIG. 2, a flowchart 200 depicting a control method of the present invention is provided in accordance with an embodiment of the present invention. The method includes the step of S210 receiving wind or tide speed and tip speed ratio value. In S220 checking if wind/tide speed is above rated, if yes then in S230 checking if excess wind/tidal energy is present. If the excess energy is present, then in S230a control means move radially out at desired rate to capture the excess energy, else in S230b control means/masses do not actuate. If wind/tide speed is not above rated then in S240 checking if turbine tip speed ratio is optimum, if no, then in S250 checking if turbine tip speed ratio is above optimum. If above optimum then in S250a, control means move radially out at desired rate to bring tip speed ratio to optimum. If below optimum then in S250b, control means move radially in at desired rate to bring tip speed ratio to optimum. In S240 if turbine tip speed ratio is optimum, then in S260 checking if turbine power output at rated, if yes, then in S270 control means do not actuate. If turbine power output not at rated then in S280 checking if difference of aerodynamic and generator torque is positive, if yes, then in S280a Control means move radially out to provide a negative inertial torque that compensates for the positive difference of aerodynamic and generator torque on the turbine drive train thereby capturing the excess energy and stabilizing the electrical power output of the turbine generator. If no, then in S290 check if difference of aerodynamic and generator torque is positive, if it is positive, then in S290a Control means move radially in to provide a positive inertial torque that compensates for the negative difference of aerodynamic and generator torque on the turbine drive train thereby maximizing and stabilizing the electrical power output of the turbine generator, else in S290b, control means do not actuate.

In an embodiment, the generator torque refers to the electrical torque, generated because of rotating magnetic field, acting on a generator shaft.

In an embodiment, while fluid velocity goes above rated velocity of turbine, the amount of energy (in unit time) beyond rated may be termed as excess fluid energy. Furthermore, any wind energy that is bound to cause undesired acceleration or increase in electrical power output of a turbine can be termed as excess fluid energy. It shall be apparent to a person skilled in the art that the fluid may be wind in case of wind turbine or it may be water in case of tidal turbines.

In an embodiment, optimum tip speed ratio (λₒ) is the ratio at which tangential speed of the tip of the blade is at value where the turbine is generating maximum possible electrical power output, without violating its electrical limitations and stability constraints, noise and mechanical loading constraints.

In a related embodiment, the present invention provides the controller encoded with instructions enabling the controller to actuate and control position, speed and acceleration of the at least one control means thereby controlling the rate of change of moment of inertia (dI/dt) of the turbine in order to control a net torque acting on a drive train of the turbine. The at least one control means is actuated to move in the rotor plane radially outwards or radially inwards for providing the turbine a decelerating torque or an accelerating torque respectively thereby recalibrating a tip velocity of the turbine rotor to an optimum tip speed ratio for an undisturbed velocity (Vinf) such that the turbine operates at a maximum efficiency. The controller includes artificial intelligence-based processing logic to predict the undisturbed velocity pattern and a corresponding actuation pattern of the control means where pre-sensing and forecasting of the undisturbed wind/tidal energy enables avoiding dealy in actuation of the control means.

In an embodiment, the energy balance of the control mechanism for turbine is given as: Net Kinetic Energy in Wind Available (We−La)=Rotational Kinetic Energy of Rotor (Blades & Rotor without movable weights) (RKe)+Rotational Kinetic Energy Absorbed (or exuded) by movable weights (Te)+Linear Work done by the movable weights (Tt)+Energy Extracted by Main Generator (Ge).

Where, RKe is the Rotational Kinetic Energy associated with Rotor assembly (Blades & Rotor without movable weights).
(Te) is the energy absorbed (or exuded) by the movable weight inside the blades when its position is changed from r1 to r2 relative to center of rotation of turbine. When movable weights/control means actuate in outward direction, it absorbs the surplus energy (above rated wind velocity) and store them mechanically, while movable weights are pulled back inwards, it discharges or exudes this stored mechanical energy back to the rotor assembly.
Linear work done by (or on) Movable weight (Tt): Not all the excess energy (above rated wind velocity) is absorbed in rotational form by Movable weight, while it (movable weights) translates from r1 to r2 (outwardly), a part of energy will be utilized to as Linear work done by the rotor on the movable weights to move them from r1 to r2 (outwardly). This stores energy through regenerative motors while movable weights are traversed outwards as tension in guide string is released and centrifugal force will dominate which will provide torque to regenerative motor. This stored energy will be discharged back to the rotor assembly in the form of rotational kinetic energy when regenerative motors pull the weights towards the hub side of the blade which may be considered work done by the movable blades on the rotor.
(Ge) is the mechanical energy that main generator consumes to generate the electrical output which is a function of angular velocity of the rotor.

In an embodiment, the present invention provides a control system for a variable inertia wind turbine which functions as an energy storage system that utilizes the stored energy when the turbine's electrical power output is at its rated power, while the undisturbed wind velocity is above rated and there is excess wind energy present, movable masses are displaced radially outward such that excess wind energy is absorbed. The present invention is a mechanical energy storage system that stores excess wind energy present, when the undisturbed wind velocity goes above rated, partially in the form of rotational kinetic energy of the masses and rest as electrical energy in regenerative motors. The first portion of the stored energy is utilized in maintaining optimum progression of tip speed, according to control algorithms and turbine's governing mathematical relationship given in equation (1), when turbine falls below rated power, thus generating more power.

In an example embodiment, the present invention converts wind energy into movable masses radial and tangential energy which ultimately gets stored partially in the form of rotational kinetic energy of the masses and rest as electrical energy in battery storage through regenerative motors, to provide a decelerating torque (by moving the masses in accordance with the mathematical relationship given in equation (1)) when desired by the presented system. It can also use part of energy stored as electrical energy in regenerative motors and rotational kinetic energy of the masses to provide accelerating torque (in accordance with equation (1)) to the turbine when desired by the presented system.

In an embodiment, when excess torque is present, the control means/masses move radially outward to provide a decelerating torque that matches the excess torque present and converts the excess energy into movable masses radial and tangential energy stores partially in the form of rotational kinetic energy of the movable masses and rest as supplied as electrical energy to battery storage through regenerative motors. The excess torque is the torque that makes the turbine accelerate and cross its electrical limitations (rated power). The stored energy is used to provide an accelerating torque, by using a fraction of energy stored as electrical energy in regenerative motors and rotational kinetic energy of the masses when turbine is operating below rated power to maintain optimum progression of tip speed ratio according to the control algorithm through governing mathematical relationship given in equation (1).

In an exemplary embodiment, the turbine control method and system of the present invention provides a noise restricted turbine control approach. For areas with noise regulation, there are operational restrictions applicable for operation of the turbines as the noise levels are to be maintained in acceptable limits. The high noise levels may be classified as mechanical noise due to interaction between various mechanical components of the turbine like gear box, shaft, generator etc., or aerodynamic noise due to interaction between air and aerodynamic component of wind turbine like blades. The interaction with blade tip or wind interaction with blade and tower generate noise. Since, noise production is a function of turbine's tip velocity, due to noise restrictions, the turbine local control may restrict tip velocity to be maintained below a specific tip velocity, which may be called as V_{tip_noise} and a corresponding undisturbed wind velocity that gives optimum tip speed ratio, λo is termed as V_{inf_noise}. V_{tip_noise} is that maximum value of tip velocity (Vₜᵢₚ) at which the noise production of the turbine is maintained under acceptable limit.

In an embodiment the present invention includes increasing a generator torque demand value when the turbine operates below rated power output condition and a tip speed ratio is equal to an optimum tip speed ratio or a rotor tip speed is equal to maximum permissible tip speed for the turbine (in case of noise restrictions) where the increase in generator torque demand value is such that a difference of an aerodynamic torque and the generator torque is equal to a maximum positive inertial torque value permissible without violation of electrical limitations of generator and limitations of the at least one control means.

In an embodiment, if V_{inf}<Vₙₒᵢₛₑ while, tip speed ratio is greater than optimum tip speed ratio, a turbine supervisory control module actuates the disposed masses to move in the rotor plane radially outwards to provide decelerating torque to the turbine system, and to bring turbine rotor's tip velocity value near or equal to the value that corresponds to optimum tip speed ratio for undisturbed velocity (V_{inf}) at that instance to lengthen the duration of maximum efficiency operations of the wind turbine. Further, While tip speed ratio is less than optimum tip speed ratio, the turbine supervisory control module actuates the disposed masses to move in the rotor plane radially inwards to provide accelerating torque to the turbine system, and to bring turbine rotor's tip velocity value near or equal to the value that corresponds to optimum tip speed for such undisturbed velocity (V_{inf}) at that instance to lengthen the duration of maximum efficiency operations of the wind turbine. Furthermore, while tip speed ratio is equal to optimum tip speed ratio, the turbine supervisory control module increases the generator torque demand to a value such that the difference of aerodynamic torque and generator torque is equal to the maximum possible value of positive inertial torque that could be provided. Even while achieving the maximum possible value, the system also ensures no violation of the electrical limitations of wind turbine generator and limitations of mass actuation system. The next time, the masses are moved radially inwards, thereby maximizing the electrical power output of the turbine without affecting the angular velocity (ωᵣₒₜ) of the turbine.

In an exemplary embodiment, the controller of the turbine is configured to achieve an angular velocity (ωᵣₒₜ) and an angular acceleration (αᵣₒₜ) on the drivetrain of the turbine by actuating at least one control means in the turbine to achieve required rate of change of moment of inertia.

In an embodiment, if Vₙₒᵢₛₑ<V_{inf}<V_{rated}, the supervisory control module increases the generator torque demand to a value such that the difference of aerodynamic torque and generator torque is equal to the maximum possible value of positive inertial torque that could be provided. Even while achieving the maximum possible value, the system also ensures no violation of the electrical limitations of wind turbine generator and limitations of mass actuation system. The next time, the masses are moved radially inwards by using part of the energy stored to operate regenerative motors, thereby maximizing the electrical power output of the turbine without affecting the angular speed (ωᵣₒₜ) of the turbine.

In an embodiment, if V_{inf}>V_{rated}, the turbine supervisory control module actuates the disposed masses to move at computed desired position, speed and acceleration, to provide a balancing (positive or negative) inertial torque, so as to store the maximum amount of excess wind energy into movable masses radial and tangential kinetic energy to be further stored through energy storage means, which is later supplied to generator while radially disposed masses are moved at computed/required/desired position, speed and acceleration to maximize electrical energy output of generator.

In an alternate embodiment, while V_{inf} fluctuates around rated or the time duration where V_{inf} is above rated are smaller than the time required to move movable masses from hub end to tip end; then movable masses maintain electrical power around rated power by oscillating on the tip side of the blade, with desired speed and acceleration so as to provide required accelerating and decelerating torque to the turbine system in order to maximize the energy output of the wind turbine generator.

In an exemplary embodiment, source data i.e wind or tidal is provided to the controller where the controller is configured to operate the control means/movable masses based on estimation or prediction of direction and amount of wind or tidal flow to be received at the turbine. The system utilizes predictive modelling, Light Detection and Ranging or LiDAR technology or any other wind speed pre-sensing equipment is deployed onto the turbine. While the undisturbed wind velocity (V_{inf}) falls below rated for a short momentary duration and rise back again above rated, then the movable masses are pulled radially inward with desired speed and acceleration to maintain rated power. The masses are moved by utilizing a first portion of energy stored in a battery storage through regenerative motors and a second portion of rotational kinetic energy of the masses to provide an accelerating torque to compensate for the rotational deceleration, arising out of falling wind velocity.

In an exemplary embodiment, the present invention provides a control method for mitigating wind power curtailment events due to transient and dynamic power stability issues grid stability according to frequency requirements and system stability in both noises restricted and unrestricted horizontal axis and vertical axis wind turbine and other kinds of turbines.

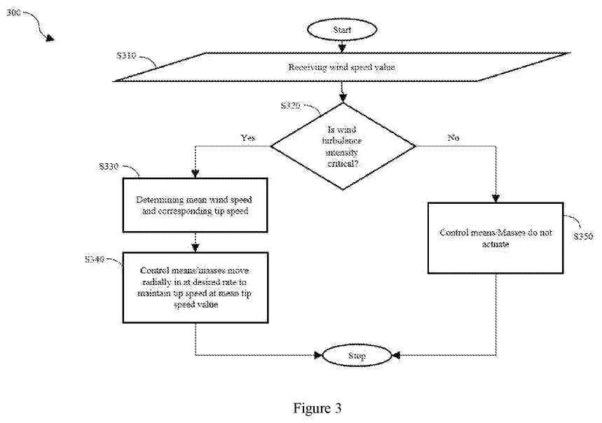

In an embodiment, based on the values of undisturbed wind velocity, turbulence, wake induced turbulence, surface constraint effects, wind shear effects, topological and structural effects, coefficient of thrust on the upstream turbines and turbulence intensity (TI) of free stream wind velocity is calculated and classified as critical or non-critical. Referring to FIG. 3, a flow diagram 300 depicting the method of checking turbulence intensity (TI) is provided. In S310 receiving wind speed value. In S320 checking if wind turbulence intensity is critical, if yes then, in S330 determining mean wind speed and corresponding tip speed and in S340 control means/masses move radially in at desired rate to maintain tip speed at mean tip speed value. If wind turbine intensity is not critical then in S350 control means/masses do not actuate. The present invention determines and classifies the turbulence intensity of an undisturbed wind or tidal energy as critical or non-critical for providing an input to the controller where the controller is configured for determining a mean wind or tidal velocity Vmean and a corresponding angular velocity that is to be maintained by actuating the at least one control means for achieving the rate of change of moment of inertia.

In a related embodiment, in case the turbulence intensity of free stream wind velocity is classified as critical, then using a continuous probability distribution function an average V_{inf} would be calculated as Vₘₑₐₙ while LiDAR pre-sensing of wind or other wind pre-sensing equipment is deployed onto the turbine. Further, using predictive modelling and probability distribution function, an average or mean V_{inf} and corresponding optimum tip speed ratio and tip speed is determined/predicted for that period. In case, the turbine attempts to accelerate in that period, due to sudden increase in wind speed, above the optimum tip speed, movable masses will move radially outwards in the rotor plane to provide a decelerating torque to the system. Further, the turbine stores corresponding amount of energy from the wind that is making accelerating the turbine accelerate beyond optimum tip speed, at that instance, partially in the form of rotational kinetic energy of the masses and rest as electrical energy in energy storage means attached to the mass actuation system. In case, the turbine tries to decelerate in that period, due to sudden decrease in wind speed, to a Vₜᵢₚ below optimum tip speed, the said movable masses will move radially inwards in the rotor plane and compensate/nullify for the net negative decelerating torque with an accelerating torque provided by the control system. The mases are moved by using a fraction of energy stored in from of rotational kinetic energy of the said masses and energy storage means attached to the mass actuation system. Using the control system of the present invention, a more stable power output is maintained even if the aerodynamic loads are fluctuating. This in turn would reduce the number of wind power curtailments events occurring in a year due to fluctuating aerodynamic loads and hence increase the annual energy output of the turbine. Further, the control system ensures transient and dynamic stability in wind turbine's power output.

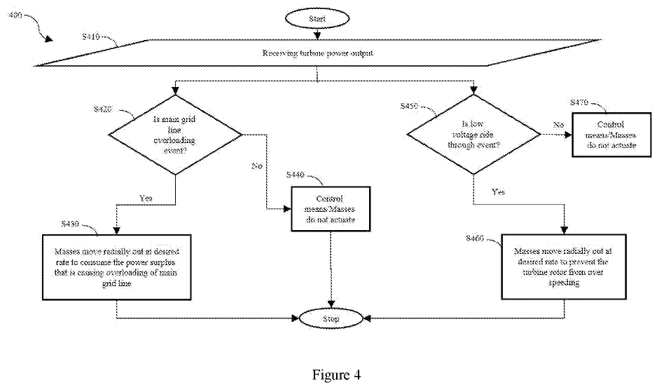

In an exemplary embodiment, the present invention provides a control system and method for grid stability for overloading of main wind farm grid line in both noise restricted and unrestricted HAWT's and VAWT's and other kind of wind turbines. Referring to FIG. 4, a flowchart 400 depicting the method of control of LVRT and grid line overloading event is provided. In S410, receiving turbine output power. In S420 checking if main grid line overloading event, if yes, then in S430, masses move radially out at desired rate to consume the power surplus that is causing overloading of main grid line else if no, then in S440 control means/masses do not actuate. In S450 checking if low voltage ride through event, if yes then in S460, control means/masses move radially out at desired rate to prevent the turbine rotor from over speeding else if no, then in S470 control means/masses do not actuate.

In an example embodiment, the control system and method for grid stability at wind farm level includes a current transducer at the connection point to main grid line for the whole wind farm which senses as to whether the grid line is getting electrically overloaded/clogged or not. If the line is clogged/overloaded, then the wind farm master controller (FMC) would identify, by taking control means/mass position inputs from all the turbine controllers, the turbines in which masses have the maximum capacity to consume aerodynamic power to store energy. If the identified turbines are not capable of causing a power dip required to unclog the main grid line, then other turbines, who's amount of cumulative energy consumed the next time by radially disposed masses is not that high will also be taken into account for causing the required power dip. From the identified turbines, a certain amount of turbines, depending upon the power curtailment required to unclog the main grid line, will be instructed to move the said masses radially outwards in their rotor plane with respective speeds that have been computed by the wind farm master controller so as to convert some of the wind energy into movable weight's radial and tangential energy which ultimately gets stored partially in the form of rotational kinetic energy of the masses and rest as electrical energy in energy storage means attached to the said masses, hence, making the net torque on turbine negative (Ta−Tg). This control protocol will make the selected turbines decelerate and reduce their electrical power output for unclogging thereby decreasing the power output of the whole wind farm to value corresponding to 95-99% of the wind farm's main grid line power dispatching threshold.

In an exemplary embodiment, the present invention provides a Control system and method for (handling fluctuations in electrical power)/(malfunctioning of generator torque actuation control algorithm) due to air density variations in both Noise restricted and unrestricted HAWT's and VAWT's and other kind of turbines. If the value of air density is higher than the value assumed in generator torque actuation control algorithm then, the system of the present invention converts the excess energy into movable masses radial and tangential energy by moving the masses radially inwards with required speed and acceleration computed by the presented controller, to achieve the required rate of change if moment of inertia to compensate for the net positive difference of aerodynamic and generator torque with negative inertia torque, and store the excess wind energy partly as rotational kinetic energy of the said masses and partly as electrical energy in the energy storage means attached to the said mass actuation system. If the value of air density is lower than the value assumed in generator torque actuation control algorithm, the present system use this energy stored in electrical energy storage means attached to the said masses to move the disposed masses radially inwards in with desired speed and acceleration as computed by the presented controller, to achieve the required rate of change of moment of inertia energy to provide and inertia torque equation to the net negative difference of aerodynamic and generator torque.

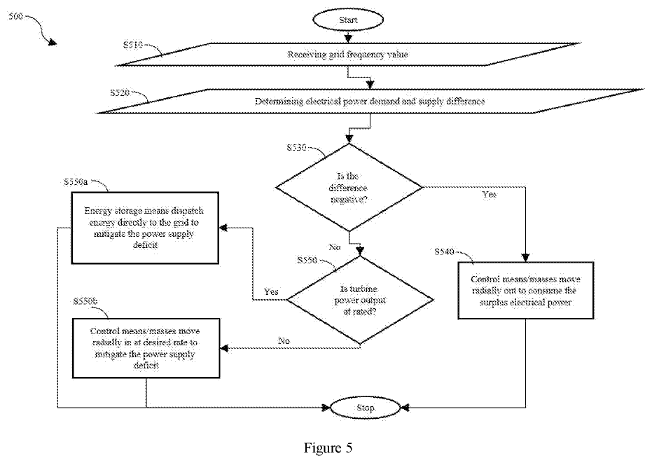

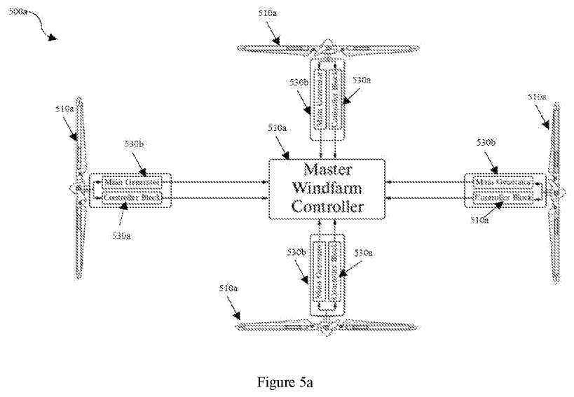

In an embodiment the present invention provides a Control method for stabilizing grid frequency HAWT's and VAWT's and other kind of turbines. Referring to FIG. 5 a flowchart 500 depicting the control method for stabilizing grid frequency is provided. In S510, the windfarm master controller takes grid frequency as input and in S520 the difference between electrical power demand and electrical power supply is determined. In S530, checking if the difference is negative, if yes, then in S540, the wind farm master controller would identify the turbines in which masses have capacity to store energy at required rate. The controller receives mass position inputs from all the turbines to identify the turbine having additional capacity. The masses in the identified turbines are then instructed to move radially outwards by their individual controllers at respective speeds computed by the wind farm master controller so as to make the net torque acting on the turbine negative and convert some of the wind and electrical energy into the said masses radial and tangential energy which gets stored partially as rotational kinetic energy of the masses and rest in energy storage means attached to the said masses. This farm protocol will make the identified/selected turbines decelerate and reduce their electrical power output, thereby making the power demand and supply difference zero. If the difference is positive, then in S550 checking if the turbine output power is at rated. If power is rated then in S550a, energy storage means dispatch energy directly to the grid to mitigate the power supply deficit, else in S550b, control means/masses move radially in at desired rate to mitigate the power supply deficit. In short, the control method of the present invention determines a difference between a power demand and power supply of the turbine using a grid frequency where the at least one control means is actuated to move radially outwards for providing negative inertial torque to deliver decelerating torque to the turbine if the difference is negative and the at least one control means is actuated to move radially inwards for providing positive inertial torque to deliver accelerating torque to the turbine if the difference is positive.

In an embodiment, the present invention provides a plurality of turbines 510a in a wind farm 500a as shown in FIG. 5a. The wind farm includes the master controller 520a that would identify the turbines in which masses have capacity to dispatch their stored energy at required rate. The controller 520a receives mass position inputs from all the turbines to identify the turbine having capacity to dispatch. Each of the plurality of turbines 510a include a controller 530a and generator 530b. The control means/masses in the identified turbines are then instructed to move radially inwards by their individual controllers at respective speeds computed by the wind farm master controller to make the net torque acting on the respective turbines positive by utilizing a portion of rotational kinetic energy of the masses and energy stored in energy storage means attached to the said masses. This farm protocol will make the identified/selected turbines accelerate and increase their electrical power output, thereby making the power demand and supply difference zero.

In an advantageous aspect, the control process of the present invention results in increased stability in windfarm power output and ensure transient, dynamic and steady state stability in grid's frequency while at the same time it would increase the annual energy production of the overall windfarm.

In an exemplary embodiment, the present invention provides energy efficiency control system and method in accordance with a grid stability. The controller of each of the turbines is encoded with instructions enabling the controller to process information received from the turbine for making the turbine to go to optimum tip speed ratio, when Vinf is below rated power output. Also, at the same time the controller maintains grid stability or synchronization of wind turbine generator power output with grid's power demands by actuating generator torque (generator magnetization) such that (_{generator} ω_{current}=P_{load}). The balance torque is provided (difference between aerodynamic torque, generator torque demand and torque required to make turbine reach optimum tip speed ratio) by WindTRAIN technology (by mechanism working on principle mentioned above). Hence, WindTRAIN would serve both purposes of maintaining stability in grid's frequency while at the same time lengthening max energy efficiency operations of wind turbine. When Vinf is above rated power output, windTRAIN and pitch work together to prevent turbine from crossing its electrical limitations. The pitch maintains balance of aerodynamic and generator torque (ₐₑᵣₒ−_{gen}) equal to the negative torque that windTRAIN provides in next instance during above V_{rated} conditions thereby preventing the turbine from crossing it's electrical limitation. At the same time, the system harnesses the energy present in wind above V_{rated} conditions through the control process.

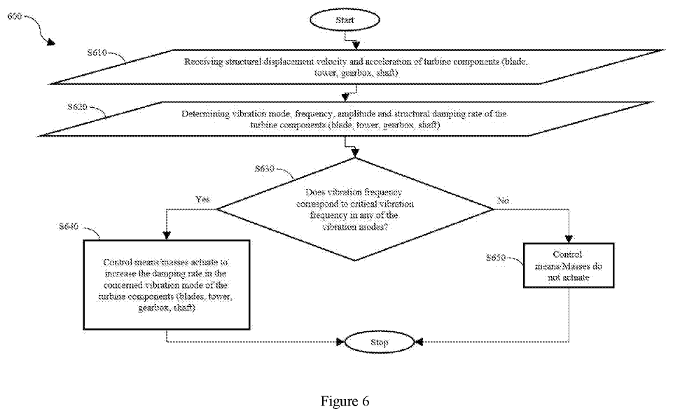

In an embodiment, the rapidly changing aero Loads or gusts and lulls excite the critical vibration conditions such as resonant frequencies in different major modes of turbine components such as turbine tower, shaft, gearbox and blades. Referring to FIG. 6 a flowchart 600 depicting control method in mechanical vibration conditions. In S610, Receiving structural displacement velocity and acceleration of turbine components (blade, tower, gearbox, shaft). In S620, determining vibration mode, frequency, amplitude and structural damping rate of the turbine components (blade, tower, gearbox, shaft). In S630, checking if vibration frequency corresponds to critical vibration frequency in any of the vibration modes, if yes then, in S640 control means/masses actuate to increase the damping rate in the concerned vibration mode of the turbine components (blades, tower, gearbox, shaft), else if no, then in S650 control means/masses do not actuate.

In a related embodiment, the present invention includes turbine components like a plurality of turbine blades and a tower gear box vibration sensing module for determining vibration mode, amplitude, frequency and damping rate based on a structural displacement, velocity and acceleration of the blades where if frequency of vibration in any of the components corresponds to critical value, a desired positive or negative inertial torque is provided to the turbine system by actuation of the at least one control means to increase a damping rate of vibrations in a concerned mode of vibration of the components.

In case of gusts, lulls or fluctuating aerodynamic loads, the movable masses actuate in a way that, in case of sharp increase of V_{inf}, the excess torque that would try to cause a sudden rotational acceleration of turbine's rotor will be matched by a decelerating torque provided by means of the masses moving radially inwards in the rotor plane with desired speed and acceleration as computed by the controller. The system converts the excess wind energy into movable weight's radial and tangential energy which ultimately gets stored partially in the form of rotational kinetic energy of the masses and rest as electrical energy in energy storage means attached to the masses to stop the acceleration of turbine. In case of sharp decrease of Vinf, an accelerating torque is provided to the turbine by the control system by using a fraction of energy stored as electrical energy in energy storage means and rotational kinetic energy of the masses. The accelerating torque prevents sudden deceleration of the turbine thereby reducing the vibration in amplitude and frequency in turbine's major structural components.

In an embodiment, if the turbine is operating in below rated power output and tip speed ratio equals to optimum tip speed ratio or rotor tip speed is equal to maximum permissible tip speed for the turbine, then at least one control means is actuated to move radially outwards for providing negative inertial torque to deliver decelerating torque to the turbine if the difference between aerodynamic and generator torque is positive and the at least one control means is actuated to move radially inwards as the second direction for providing positive inertial torque to deliver accelerating torque to the turbine if the difference between aerodynamic and generator torque is negative.

In case of nayying critical vibration frequency condition, the control means/movable masses are actuated such that a change in torque acting on the drive train of turbine takes place at a frequency higher or lower than the frequency that excites the critical vibration frequency condition in nayying mode of turbine thereby increasing the vibration damping rate in the mode.

In case of generator shaft torsion and gearbox teeth edgewise critical vibration frequency excitation condition, the control means/movable masses are actuated such that a change in torque, acting on the drive train of the turbine takes place at a frequency higher or lower than the frequency that excites the critical vibration frequency condition in shaft torsion and gearbox teeth edgewise displacement mode thereby increasing the vibration damping rate in the modes.

In case of nodding critical vibration excitation condition, the movable masses actuate such that a change in thrust acting on the tower takes place at a frequency higher or lower than the frequency that excites critical vibration frequency condition in nodding mode of tower thereby increasing the vibration damping rate in the mode.

In case of critical vibration excitation condition in flap-wise and edgewise direction of blades (with default value of damping ratio), the control means/masses are actuated to change the geometry of the blade and the force acting on the blade walls in a way that increases the damping rate of vibrations in edgewise and flap-wise direction blades and hence reduce the damage to blades due to critical vibration frequency excitation condition in edgewise and flap-wise vibration mode of blade respectively.

In an exemplary embodiment, the at least one control means is actuated in a manner to achieve a net positive gravitational torque on the turbine drive train in a direction of rotation of rotor when an angular speed of the turbine rotor is zero wherein the torque is enough to overcome an integral loss of the system and accelerate the turbine thereby lengthening power production phase of the turbine.

In some implementations, the controller of the present invention utilizes machine learning model configured and trained to detect and/or predict objects like the wind flow at the turbine depending on historical data, predicted weather conditions and patterns. For example, output generated over the model may provide an indication of whether a particular object or class of objects is present, and optionally user instructions. In some implementations, the machine learning model is configured and trained to detect and/or predict the performance pattern of multiple objects or multiple classes of objects. Accordingly, in those implementations a single pass over a single machine learning model may be utilized to detect whether each of multiple objects is present and/or to predict poses of those present object(s). For example, output generated over the model may provide an indication of whether a first particular object or class of objects is present, and indication of whether a second particular object or class of object is present, etc.—and optionally performance for one or more of the particular objects or classes indicated to be present.

It will be apparent that different aspects of the description provided above may be implemented in many different forms of software, firmware, and hardware in the implementations illustrated in the figures. The actual software code or specialized control hardware used to implement these aspects is not limiting of the invention. Thus, the operation and behavior of these aspects were described without reference to the specific software code—it being understood that software and control hardware can be designed to implement these aspects based on the description herein.

Further, certain portions of the invention may be implemented as a “component” or “system” that performs one or more functions. These components/systems may include hardware, such as a processor, an ASIC, or a FPGA, or a combination of hardware and software.

The word “exemplary” is used herein to mean “serving as an example.” Any embodiment or implementation described as “exemplary” is not necessarily to be construed as preferred or advantageous over other embodiments or implementations.

No element, act, or instruction used in the present application should be construed as critical or essential to the invention unless explicitly described as such. Also, as used herein, the article “a” and “one of” is intended to include one or more items. Further, the phrase “based on” is intended to mean “based, at least in part, on” unless explicitly stated otherwise.

Each of the above identified processes corresponds to a set of instructions for performing a function described above. The above identified programs or sets of instructions need not be implemented as separate software programs, procedures or modules, and thus various subsets of these modules may be combined or otherwise re-arranged in various embodiments. For example, embodiments may be constructed in which steps are performed in an order different than illustrated, steps are combined, or steps are performed simultaneously, even though shown as sequential steps in illustrative embodiments. Also, the terminology used herein is for the purpose of description and should not be regarded as limiting. The use of “including,” “comprising,” “having,” “containing” and variations thereof herein, is meant to encompass the items listed thereafter and equivalents thereof as well as additional items.

The above-described embodiments of the present invention may be implemented in any of numerous ways. For example, the embodiments may be implemented using various combinations of hardware and software and communication protocol(s). Any standard communication or network protocol may be used, and more than one protocol may be utilized. For the portion implemented in software, the software code may be executed on any suitable processor or collection of processors, whether provided in a single computer or distributed among multiple computers. Such processors may be implemented as integrated circuits, with one or more processors in an integrated circuit component, or any other suitable circuitry.

Also, the various methods or processes outlined herein may be coded as software that is executable on one or more processors that employ any one of a variety of operating systems or platforms. Additionally, such software may be written using any of a number of suitable programming languages and/or programming or scripting tools or a combination of programming languages, and also may be compiled as executable machine language code or intermediate code that is executed on a framework or a virtual machine. In this respect, the invention may be embodied as a computer readable storage medium (or multiple computer readable media) (e.g., a computer memory, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form.

The terms “program” or “algorithm” or “software” are used herein in a generic sense to refer to any type of computer code or set of computer-executable instructions that may be employed to program a computer or other processor to implement various aspects of the present invention as discussed above. Additionally, it should be appreciated that according to one aspect of this embodiment, one or more computer programs that when executed perform methods of the present invention need not reside on a single computer or processor but may be distributed in a modular fashion amongst a number of different computers or processors to implement various aspects of the present invention. Computer-executable instructions may be in many forms, such as program modules, executed by one or more computers or other devices. Also, data structures may be stored in computer-readable media in any suitable form. Any suitable mechanism may be used to establish a relationship between information in fields of a data structure, including the use of pointers, tags, or other mechanisms that establish relationship between data elements.

It is to be understood that the above-described embodiments are only illustrative of the application of the principles of the present invention. The illustrative discussions above are not intended to be exhaustive or to limit the invention to the precise forms disclosed. Various modifications and alternative applications may be devised by those skilled in the art in view of the above teachings and without departing from the spirit and scope of the present invention and the following claims are intended to cover such modifications, applications, and embodiments.

We claim:

1. A control method for operating a turbine, the method comprising the steps of:
actuating at least one control means coupled to the turbine in a first direction when the turbine operates above a rated power output on receipt of excess energy wherein a first portion of the excess energy is stored as energy of the actuated control means;
storing a second portion of the excess energy in at least one storage means, and
actuating at least one control means in a second direction by the stored energy when the turbine operates below the rated power output, wherein the at least one control means is actuated in the first direction or the second direction to control the rate of change of moment of inertia of the turbine.

2. The method of claim 1 wherein a controller encoded with instructions enabling the controller to actuate and control position, speed and acceleration of the at least one control means thereby controlling the rate of change of moment of inertia (dI/dt) of the turbine in order to control a net torque acting on a drive train of the turbine.

3. The method of claim 2 wherein the at least one control means is actuated to move in the rotor plane radially outwards as the first direction or radially inwards as the second direction for providing the turbine a decelerating torque or an accelerating torque respectively thereby recalibrating a tip velocity of the turbine rotor to an optimum tip speed ratio for an undisturbed velocity (Vinf) such that the turbine operates at a maximum efficiency.

4. The method of claim 2 further comprises the step of increasing a generator torque demand value when the turbine operates below rated power output condition and a tip speed ratio is equal to an optimum tip speed ratio or a rotor tip speed is equal to maximum permissible tip speed for the turbine wherein the increase in generator torque demand value is such that a difference of an aerodynamic torque and the generator torque is equal to a maximum positive inertial torque value permissible without violation of electrical limitations of generator and limitations of the at least one control means.

5. The method of claim 4 further comprises the step of determining and classifying a turbulence intensity of an undisturbed wind or tidal energy incident on the turbine as critical or non-critical for providing an input to the controller wherein the controller is configured for determining a mean wind or tidal velocity Vmean and a corresponding angular velocity of the turbine that is to be maintained by actuating the at least one control means for achieving the rate of change of moment of inertia.

6. The method of claim 2 further comprises the step of determining a difference between a power demand and power supply of the turbine using a grid frequency wherein the at least one control means is actuated to move radially outwards for providing negative inertial torque to deliver decelerating torque to the turbine if the difference is negative and the at least one control means is actuated to move radially inwards as the second direction for providing positive inertial torque to deliver accelerating torque to the turbine if the difference is positive.

7. The method of claim 2 further comprises the step of determining a difference between an aerodynamic and a generator torque wherein the at least one control means is actuated to move radially outwards for providing negative inertial torque to deliver decelerating torque to the turbine if the difference is positive and the at least one control means is actuated to move radially inwards as the second direction for providing positive inertial torque to deliver accelerating torque to the turbine if the difference is positive.

8. The method of claim 6 further comprises the step of moving the at least one control means radially outwards to provide negative inertial torque to deliver decelerating torque to the turbine in case of a low voltage ride through (LVRT) or main grid line overloading event thereby preventing damage due to electrical overloading and over speeding of turbine rotor.

9. The method of claim 2 wherein the at least one control means is masses positioned in rotor planes of the turbine and configured for moving inward as the second direction or outward as the first direction in a radial direction in the rotor plane.

10. The method of claim 2 wherein the at least one control means is actuated in a manner to achieve a net positive gravitational torque on the turbine drive train in a direction of rotation of rotor when an angular speed of the turbine rotor is zero wherein the torque is enough to overcome an integral loss of the system and accelerate the turbine thereby lengthening power production phase of the turbine.

11. The method of claim 2 wherein the controller is configured to achieve an angular velocity (ωᵣₒₜ) and an angular acceleration (αᵣₒₜ) on the drivetrain of the turbine by actuating at least one control means in the turbine to achieve required rate of change of moment of inertia.

12. The method of claim 8 wherein the control means provides a balancing inertial torque while excess wind or tidal energy is present at the turbine and an excess torque is present at rotor, thereby enabling storage of the first portion of the excess wind or tidal energy as a radial and a tangential kinetic energy of the control means wherein the second portion of the energy stored in the energy storage means is provided to a turbine generator while the control means are moved in the rotor plane at a required position, speed and acceleration to maximize electrical energy output of the generator.

13. A control system for operating a turbine, the system comprises:
at least one control means coupled to a turbine rotor plane wherein the control means actuates in a first direction when the turbine operates above a rated power output on receipt of excess energy wherein a first portion of the excess energy is stored as energy of the actuated control means;
at least one storage means configured for storing a second portion of the excess energy wherein the at least one control means is actuated in a second direction by the stored energy when the turbine operates below the rated power output; and
a controller encoded with instructions enabling the controller to actuate the at least one control means in the first direction and the second direction to control the rate of change of moment of inertia of the turbine.

14. The system of claim 13 wherein the controller includes artificial intelligence-based processing logic to predict undisturbed V_{inf} pattern and corresponding actuation pattern of the at least one control means including position, speed and acceleration of the at least one control means thereby controlling the rate of change of moment of inertia (dI/dt) of the turbine wherein pre-sensing and forecasting of undisturbed wind or tidal energy enables avoiding delay in actuation of the at least one control means.

15. The system of claim 13 further comprises a turbine components like a plurality of turbine blades and a tower gear box vibration sensing module for determining vibration mode, amplitude, frequency and damping rate based on a structural displacement, velocity and acceleration of the blades wherein if frequency of vibration in any of the components corresponds to critical value, a desired positive or negative inertial torque is provided to the turbine system by actuation of the at least one control means to increase a damping rate of vibrations in a concerned mode of vibration of the components.

16. The system of claim 13 wherein the energy storage means dispatches an electrical energy to a grid and also actuates the rate of change of moment of inertia of the turbine rotor such that an angular velocity of the turbine rotor and an electrical power output of a turbine generator is maximum and stable thereby stabilizing a grid frequency.

17. A turbine farm control system comprising:
a plurality of turbines wherein each of the plurality of turbines include:
at least one control means coupled to a turbine rotor plane wherein the control means actuates in a first direction when one or more of the plurality of turbines operates above a rated power output on receipt of excess energy wherein a first portion of the excess energy is stored as energy of the actuated control means;
at least one storage means configured for storing a second portion of the excess energy wherein the at least one control means is actuated in a second direction by the stored energy when the one or more turbines operates below the rated power output, and
a controller encoded with instructions enabling the controller to actuate the at least one control means in the first direction and the second direction to control a rate of change of moment of inertia of the one or more turbines; and
a master controller encoded with instructions enabling the master controller to control the plurality of turbines and thereby controlling actuation of the at least one control means of one or more turbines of the plurality of turbines in the first direction and the second direction to control rate of change of moment of inertia of each of the plurality of turbines wherein the master controller is configured for operating each of the plurality of turbines such that a maximum and stable power is generated from the turbine farm.

18. The system of claim 17 wherein the at least one control means of each of the plurality of turbines is actuated to move in the rotor plane radially outwards as the first direction or radially inwards as the second direction for providing one or more turbines a deceleration torque or an acceleration torque respectively thereby recalibrating a tip velocity of the turbine rotor near to an optimum tip speed ratio for an undisturbed velocity (Vinf) such that each of the plurality of turbines operates at a maximum efficiency.

19. A control method for operating a turbine farm, the method comprising the steps of:
determining by a master controller, a difference between an electric power demand and an electric power supply at the turbine farm based on a grid frequency;
in response to determination of the difference as negative based on receipt of excess energy, actuating at least one control means of one or more of a plurality of turbines in a first direction to make the net torque acting on the turbines negative wherein a first portion of the excess energy is stored as energy of the actuated control means;
storing a second portion of the excess energy in at least one storage means, and
in response to determination of the difference as positive based on receipt of excess energy, actuating the at least one control means of one or more of the plurality of turbines in a second direction by the stored energy to make the net torque acting on the turbines positive,
wherein the master controller is configured for identifying the one or more turbines of the plurality of turbines in the farm for deacceleration or acceleration thereby adjusting electrical power output to ensure stable electricity generation from the turbine farm.
